(19) United States
(12) Patent Application Publication
(10) Pub. No.: US 2025/0178735 A1
(43) Pub. Date: Jun. 5, 2025

(54) PIECE OF FURNITURE PROVIDED WITH A NOISE-ABSORBING COMPOSITE PANEL

(71) Applicant: Safran Seats, Plaisir (FR)

(72) Inventors: Gérald Cotta, Moissy-Cramayel (FR); Laura Olivas, Moissy-Cramayel (FR); Arthur K. Glain, Moissy-Cramayel (FR); Denis Manceau, Moissy-Cramayel (FR); Christian Verny, Moissy-Cramayel (FR)

(21) Appl. No.: 18/843,087

(22) PCT Filed: Mar. 3, 2023
(86) PCT No.: PCT/EP2023/055455

§ 371 Date: Aug. 30, 2024

(30) Foreign Application Priority Data
Mar. 11, 2022 (FR) 2202148

(51) Int. Cl. B64D 11/06; B32B 3/12; B32B 3/26; B32B 15/14; B32B 15/20; B32B 27/12; B32B 27/34; G10K 11/172

(52) U.S. Cl. CPC B64D 11/0606; B32B 3/12; B32B 3/266; B32B 15/14; B32B 15/20; B32B 27/12; B32B 27/34; G10K 11/172; B32B 2262/101; B32B 2262/106; B32B 2479/00; B32B 2605/18

(57) ABSTRACT

The present invention relates to a piece of furniture intended for installation in an aircraft cabin and including a composite panel comprising:
a first skin,
a second skin, and
a central honeycomb core arranged between the first skin and the second skin, said central honeycomb core comprising a plurality of cells,
at least one of the first skin and the second skin including a plurality of through-holes so as to render said skin permeable to sound in order for the cells of the central honeycomb core to act as sound traps.

The present invention relates to a furniture element provided with a noise-attenuating composite panel. The invention finds a particularly advantageous, but not exclusive, application with seat units of the “business class” and “first class” type in an aircraft cabin.

In a manner known per se, such a seat unit comprises a seat and a shell extending at least partly around the seat so as to delimit a space around the passenger. Such a configuration guarantees the privacy of the passenger on the seat.

The seat offers the passenger different comfort positions, from a “seating” position to a “reclining” position, in which the seat substantially horizontal sleeping surface so that the passenger can lie down. Intermediate comfort positions are also offered, such as the “relax” position in which one of the seat backs is strongly inclined. Generally, these intermediate positions are obtained by the inclination of the pivoting seat back around a horizontal axis and perpendicular to an axis of extension of the seat. The passenger can then remain on the seat during transitions among different positions. The seat generally consists in particular of the seat back and a seating surface and is likely to include a leg rest and/or a footrest, which may be fixed or linked to a kinematics of the seat.

Noise likely to disturb passengers' rest is an important environmental concern to take into consideration when developing a seat unit. There is therefore a need to reduce the perception of noise inside an aircraft cabin in order to optimize the acoustic comfort of passengers without reducing their living space.

The objective of the invention is to effectively meet this need by proposing a furniture element to be installed in an aircraft cabin and comprising a composite panel comprising:
a first skin,
a second skin, and
a central honey-combed core disposed between the first plate and the second plate, said central honey-combed core comprising a plurality of cells.
at least one of the skins among the first skin and the second skin comprising a plurality of through holes so as to make said skin permeable to sound so that the cells of the central honey-combed core operate as sound traps.

The invention thus allows, thanks to the production of through holes in the skin of the composite panel, to transform a standard honey-combed structure of the composite panel into a sound trap. In fact, the through holes allow the passage of sound waves throughout the cells of the honey-combed structure, so that after multiple reflections inside the cells, the noise intensity perceived by the passenger at the level of the seat is greatly reduced.

According to one embodiment of the invention, the first skin and the second skin each comprise several layers of glass fibers and/or carbon fibers covered by a resin.

According to one embodiment of the invention, the central honey-combed core is made of an aramid material or a metallic material, in particular aluminum.

According to one embodiment of the invention, the through holes have a larger dimension of between 0.3 mm and 10 mm and are preferably circular holes with a diameter of between 1.5 mm and 2 mm.

According to one embodiment of the invention, a perforation rate of the skin is between 1% and 50%, and is preferably 10% to 15%.

According to one embodiment of the invention, said furniture element further comprises a covering cap or a decorative film made of a sound-permeable material.

According to one embodiment of the invention, said furniture element further comprises of flexible material.

According to one embodiment of the invention, said furniture element further comprises a support structure comprising removable or integrated fixing means for interfacing with the composite panel.

According to one embodiment of the invention, the layer of flexible material is placed between the support structure and the covering cap or the decorative film.

According to one embodiment of the invention, the furniture element is constituted by a privacy shell intended to extend at least partly around a seat.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and description the of its implementation and eventually contribute to its definition, wherein:

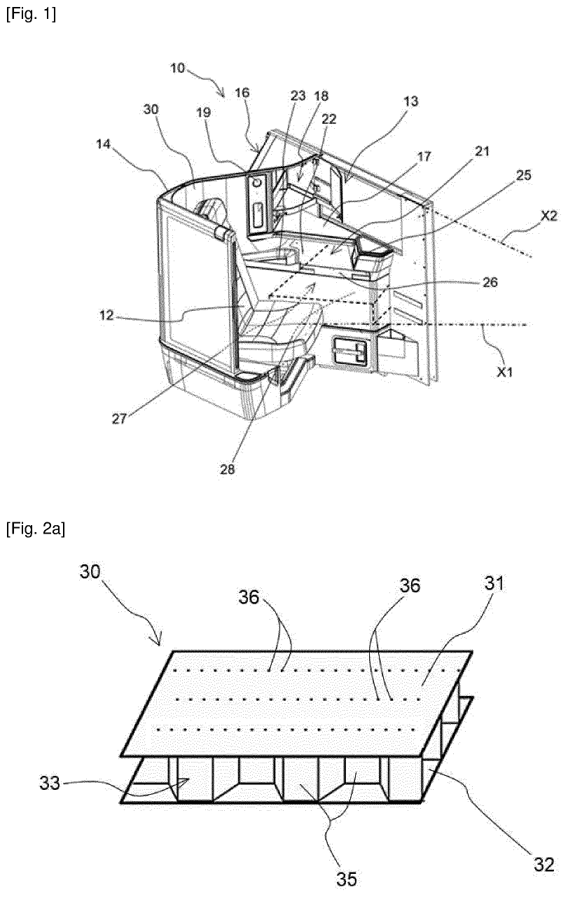

FIG. 1 is a perspective view of a seat unit according to the invention comprising a composite panel having a noise-attenuating function;

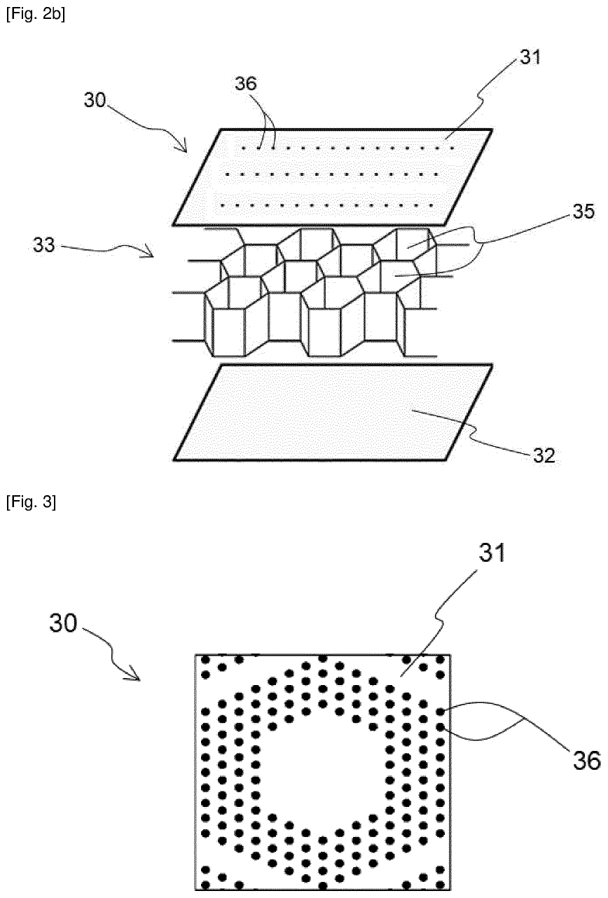

FIGS. 2a and 2b are respectively assembled perspective and exploded perspective views of a composite panel having a honey-combed structure;

FIG. 3 is a front view of a skin of a composite panel according to the invention illustrating a specific distribution of the through holes in the skin;

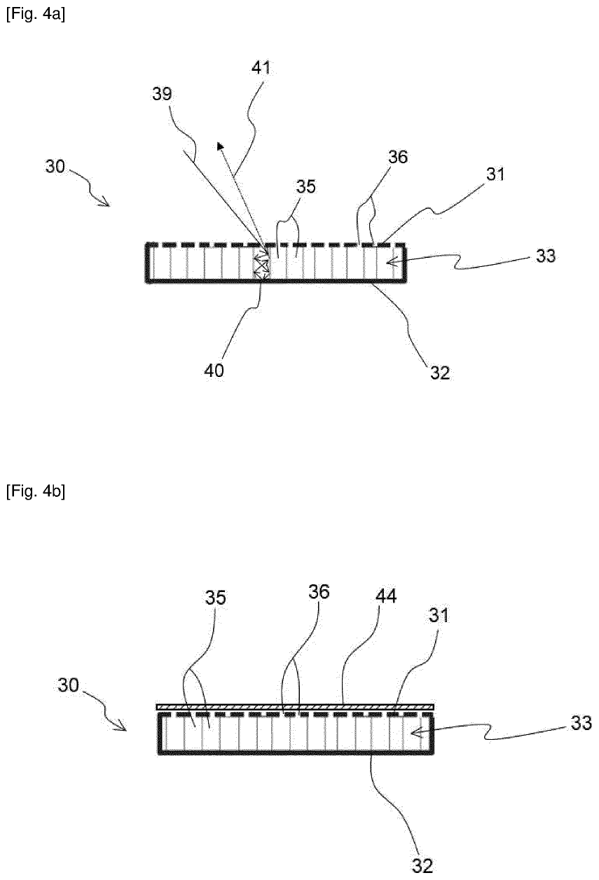

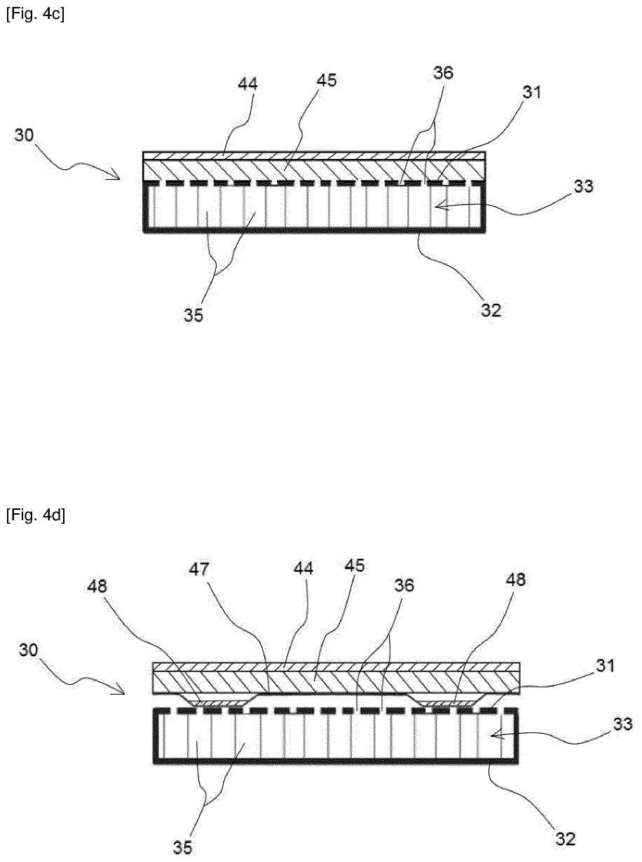

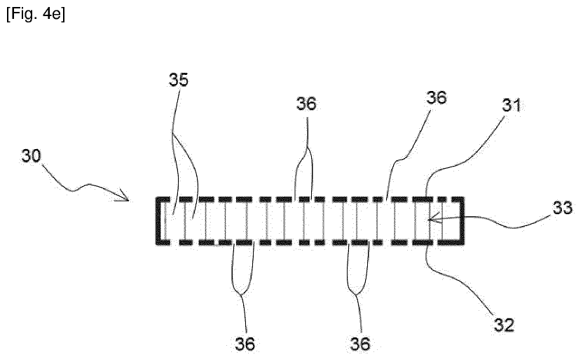

FIGS. 4a to 4e illustrate different embodiments of a composite panel according to the present invention in a side view.

It should be noted that the structural and/or functional elements common to the different embodiments have the same references. Thus, unless otherwise stated, such elements have identical structural, dimensional and material properties.

Furthermore, in the remainder of the description, the relative terms such as “front”, “rear”, “horizontal”, “vertical” are understood with reference to the common sense that a passenger seated on a seat associated with the seat unit according to the invention would give them.

FIG. 1 shows a seat unit 10 comprising a seat 12 associated with a side console 13 extending along one side of the seat 12.

Furthermore, a shell 14, so-called privacy shell, extends at least partly around the seat 12 so as to delimit a space around the passenger. The privacy shell 14 is made for example of a composite material. Such a configuration permits to guarantee the privacy of the passenger seated on the seat 12. A video screen 16 of a multimedia system or IFE (Inflight Entertainment System) could be installed on a rear part of the privacy shell 14 so as to be usable by a rear passenger.

The console 13 may include an upper wall 17 forming a table on which the passenger can place objects as well as a storage space 18 comprising one or more elements among a literature pouch, a bottle holder, or a minibar. The storage choice is configurable according to the wishes of the airline. The console 13 may also include a reading light 19 for directing light towards the seat 12.

A cavity 21 is located under the upper wall 17. The cavity 21 is laterally open towards the seat 12. In addition, a horizontal face 22 of the console 13 corresponding to a lower face of the cavity 21 has in particular an armrest function. For this purpose, the horizontal face 22 may locally have the shape of a curved cuff 23 matching the shape of part of the passenger's arm.

The console 13 also includes a control unit 25 for the seat 12 and its additional components (called “PCU” for “Passenger Control Unit”). The control unit 25 allows the passenger in particular to control the selection of a position of the seat 12 as well as the additional components, such as a video system, a heating device, an ambient lighting system or any other additional component which can be integrated into seat 12.

The seat unit 10 may also conventionally include a dining table 26 movable between a stored position (corresponding to that shown in FIG. 1) in which the dining table 26 is located inside a housing provided in the console 13 and a deployed position in which the dining table 26 is located outside the housing to allow the passenger to place a meal tray there.

The seat 12 is advantageously provided with kinematics allowing it to be movable between a “seating” position, in which the seat 12 is configured to define a seating position for a passenger, and a “lying” position, in which the seat 12 is configured to define a sleeping surface, advantageously substantially horizontal, for the passenger. Intermediate comfort positions are also offered, such as the “relax” position in which a back of the seat 12 is strongly inclined.

In order to allow the passenger to lie down, the console 13 comprises a housing 27 in a phantom view in FIG. 1 in which an ottoman 28 is arranged. The ottoman 28 has a horizontal face forming a footrest on which a rear passenger will be able to place her/his feet when the seat 12 is in the “lying” position.

The seat 12 comprises an extension axis X1 defined by the intersection of a horizontal plane and a vertical median plane of the seat 12, which corresponds to a plane of symmetry of the seat 12. The extension axis X1 of the seat 12 will be able to form a non-zero angle with respect to a direction parallel to or coincident with a central axis of the aircraft X2. In this case, the seat 12 is turned towards the axis X2. Alternatively, the seat 12 can be rotated in a direction opposite to the axis X2.

Advantageously, the privacy shell 14 comprises at least one composite panel 30 shown in FIGS. 2a and 2b. As a variant, the composite panel 30 may constitute at least in part a furniture element different from the privacy shell 14, such as for example the seat 12, the console 13, or the ottoman 28. In particular the composite panel 30 may constitute at least part of the seating surface or back of the 12. More generally, seat the invention could be implemented with any composite panel of a furniture element present in an aircraft cabin including monuments arranged in the first row or last row. Thus, within the meaning of the invention, the furniture element comprising a composite panel can take the form of the seat 12, the privacy shell 14, the console 13, the ottoman 28, a monument, or any other furniture element in the aircraft cabin (luggage rack, partition wall, or other).

The composite panel 30 comprises a front skin 31 to be located on the side of the seat 12 and a rear skin 32 to be located on the side opposite the seat 12. The front skin 31 and the rear skin 32 may take the form of a thin plate. The front skin 31 and the rear skin 32 each comprise several layers (or plies) of glass fibers and/or carbon fibers and/or fibers made of another material suitable for the application. The layers of fibers are covered by a thermoplastic or thermosetting resin. Alternatively, the front skin 31 and the rear skin 32 may be of the single-ply type. Alternatively, the front skin 31 and the rear skin 32 may be made of any other material suitable for the application, in particular a plastic, composite, or other material.

A central honey-combed core 33 is arranged between the first front skin 31 and the rear skin 32. The central honey-combed core 33 may be a honeycomb structure or any other type of honey-combed structure adapted to the application. The central honey-combed core 33 comprises a plurality of cells 35. The central honey-combed core 33 is preferably made of an aramid material, in particular of the Nomex type (registered trademark), or in a metallic material, in particular aluminum. Alternatively, the central core 33 could be made of a plastic material, a composite material, or any other material suitable for the application. The composite panel 30 may have a thickness between 0.5 cm and 3 cm.

At least one of the skins among the front skin 31 and the rear skin 32 comprises a plurality of through holes 36 so as to make said skin permeable to sound so that the cells 35 of the central honey-combed core 33 operate as sound traps. In the embodiment of FIGS. 2a and 2b, only the front skin 31 has through holes 36.

The through holes 36 preferably have a larger dimension between 0.3 mm and 10 mm, and are preferably circular holes with a diameter between 1.5 mm and 2 mm.

The through holes 36 may all have the same dimensions or be of different dimensions. Furthermore, the shape of the holes is not limited to a circular shape but can be any possible geometric shape, such as a rectangular, square, triangular, oval, hexagonal shape, or other.

A perforation rate of the skin 31 or 32 corresponding to a ratio of the area of the through holes 36 to the total area of the skin 31, 32 is between 1% and 50%, and is preferably 10% to 15%.

According to a non-limiting embodiment, for a composite panel 30 having a thickness of 1.27 cm (i.e. 0.5 inch), through holes 36 having a diameter of 1.5 mm are preferably provided with a performance rate of 10%.

The rear skin 32 may be perforated over its entire surface or only in dedicated areas, such as for example behind the support structure 47 described in more detail below.

Furthermore, the through holes 36 may be distributed homogeneously as shown in FIGS. 2a and 2b, randomly, or according to a predetermined perforation pattern, such as a hexagonal pattern as shown in FIG. 3.

As illustrated in FIG. 4a, the composite panel 30 is based on the Helmholtz principle of sound reflection inside the cavities delimited by the cells 35 of the honey-combed structure. Indeed, the through holes 36 allow the passage of sound waves 39 throughout the cavities delimited by the cells 36 of the honey-combed structure. After multiple reflections 40, the intensity of the sound wave 41 exiting the noise-attenuating panel is greatly reduced. The noise perceived by the passenger at the seat 12 is thus lower. As the composite panel 30 of the shell 14 surrounds the passenger, this creates a silent space around the passenger.

It should be noted that the composite panel 30 has been shown in FIGS. 2a and 4a as being planar in order to facilitate understanding of the invention. However, the composite panel 30 may have a curved shape so as to surround at least partly the seat 12 around which said composite panel 30 forming the privacy shell 14 extends. In order to obtain a composite panel 30 with the desired shape, a first stack of layers of prepreg is placed inside a mold, that is to say layers of composite material made of a thermosetting resin or a thermoplastic polymer impregnating glass or carbon fibers in order to form the skin 31 of composite material. The central honey-combed core 33 is then placed inside the mold. A second stack of prepreg layers is placed inside the mold in order to form the second skin 32 of composite material. The mold is then closed to ensure the shaping of the composite panel 30. The composite panel 30 is then placed inside an oven in order to polymerize the resin of composite material. The through holes 36 of the skin 31 and/or the skin 32 can be made by drilling after the production of the composite panel 30. Depending on the method chosen to manufacture said panel 30, the perforations 36 can be made by drilling or milling for example on the molded part, or on one of the skins 31, 32 or the two skins 31, 32 before molding and bonding with the honey-combed core 33. According to another method, perforations 36 can be obtained at the same time as the molding/gluing operation.

In the embodiment of FIG. 4b, it is possible to add a covering cap or a decorative film 44 made of a sound-permeable material. The material of the covering cap or of the decorative film 44 is chosen so as to give an aesthetic finish to the whole. The covering cap or the decorative film 44 could for example be made from a material such as textile, leather, imitation leather, alcantara, a laminated material, or any other material suitable for the application. The material used may include a plurality of perforations or microperforations in order to facilitate the passage of sound through the covering cap or the decorative film 44.

The covering cap 44 may have decorative patterns on its visible parts. These decorative patterns can personalized according to the airline.

In the embodiment of FIG. 4c, a layer 45 of flexible material is placed between the covering cap 44 and the composite panel 30. The layer 45 of flexible material is made of a material chosen in particular from: a fibrous material, a non-woven material, a wadding-based material, or a foam-based material or any other flexible material suitable for the application.

In the embodiment of FIG. 4d, a support structure 47 can be further provided that can be fixed to the composite panel 30. In this embodiment, the covering cap 44 is provided with a flap fixed against an edge of the support structure 47. The fixing of the flap to the support structure 47 can be carried out by gluing, riveting, insertion into a retaining groove, or any other fixing technique adapted to the application with or without gluing.

The support structure 47 is advantageously made of a thermoformed plastic material or a very high-density foam material. The support structure 47 has a low thickness, for example between 1 mm and 3 mm. According to an example of implementation, a support structure 47 made of a thermoplastic material is used.

Furthermore, the support structure 47 comprises removable or integrated fixing means 48 for fixing the assembly “covering cap 44-layer 45 of flexible material-support structure 47” on the composite panel 30. The fixing means 48 are thus intended to interface with the composite panel 30. The choice of fixing means 48 depends in particular on the integration constraints of the assembly and its positioning in the seat unit 10. In the case where the assembly is arranged in a visible area of the seat unit 10, discreet fixing means 48 which can be dismantled without the use of tools are preferably used, such as for example snap-in devices, so-called “Velcro fasteners” (registered trademark) formed by complementary loops and hooks, snap buttons, magnetic fasteners, or any other fastening device suitable for the application.

In the case where the assembly is arranged in a non-visible zone of the seat unit 10, in particular a technical zone located in the lower part of the seat unit 10, screws can be used to fix the support structure 47 on the composite panel 30 of the furniture element. Alternatively or in addition, it is also possible to use fir tree fasteners or any other fixing means suitable for the application. This type of fixing means 48 allows to guarantee the retention of the assembly in the context of certification tests during which significant decelerations are applied to the seat unit 10.

In the embodiment of FIG. 4e, the two skins 31, 32 of the composite panel 30 have through holes 36.

Of course, the different characteristics, variants and/or embodiments of the present invention can be associated with each other in various combinations insofar as they are not incompatible with or exclusive of one another. Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. Furniture element to be installed in an aircraft cabin and comprising a composite panel,
wherein the composite panel comprises:
a first skin;
a second skin; and
a central honey-combed core arranged between the first skin and the second skin, said central honey-combed core comprising a plurality of cells,
at least one of the skins among the first skin and the second skin comprising a plurality of through holes so as to make said skin permeable to sound so that the cells of the central honey-combed core operate as sound traps,
said furniture element taking the form of a seat, a privacy shell, a console, an ottoman, a monument or any other furniture element in the aircraft cabin.

2. Furniture element according to claim 1, wherein the first skin and the second skin each comprise several layers of glass fibers and/or carbon fibers covered by a resin.

3. Furniture element according to claim 1, wherein the central honey-combed core is made of an aramid material or a metallic material.

4. Furniture element according to claim 1, wherein the through holes have a larger dimension between 0.3 mm and 10 mm.

5. Furniture element according to claim 1, wherein a perforation rate of the skin is between 1% and 50%.

6. Furniture element according to claim 1, wherein said furniture element further comprises a covering cap or a decorative film made of a sound-permeable material.

7. Furniture element according to claim 1, wherein said furniture element further comprises a layer of flexible material.

8. Furniture element according to claim 1, wherein said furniture element further comprises a support structure comprising removable or integrated fixing means for interfacing on the composite panel.

9. Furniture element according to claim 6 wherein the layer of flexible material is arranged between the support structure and the covering cap or decorative film.

10. Furniture element according to claim 1, wherein it is constituted by a privacy shell intended to extend at least partly around a seat.
